(19) United States
(12) Patent Application Publication
(10) Pub. No.: US 2004/0119693 A1
(43) Pub. Date: Jun. 24, 2004

(54) Interface device with electrical energy generator

(76) Inventor: Achim Kaemmler, (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/684,807

(22) Filed: Oct. 15, 2003

(30) Foreign Application Priority Data
Dec. 20, 2002 (DE) 10260924.1

(51) Int. Cl. G09G 5/08

(52) U.S. Cl. 345/163

(57) ABSTRACT

An interface device for interfacing a user's input with a computer includes: a mechanical input device to transform a mechanical input operation of the user into an input signal for input into the computer. The mechanical input device has a movable element that the user moves to perform the input operation. An electrical generator, mechanically coupled to the moveable element, generates electrical energy that charges a battery. The battery powers circuitry used for deriving the input signal.

### CROSS-REFERENCE TO RELATED APPLICATIONS AND CLAIM OF PRIORITY

The present application corresponds to German Application DE 102 60 924.1, filed in Germany on Dec. 20, 2002, and priority thereof is hereby claimed under 35 USC 119.

### BACKGROUND OF THE INVENTION

1. Field of the Invention

The present invention relates generally to interface devices for allowing humans to interface with computer systems, and more particularly to mechanical computer interface devices that allow the user to provide input to computer systems.

2. Description of the Related Art

Computer systems are used extensively in many different industries and for private applications. Typically, users can interact with a visual environment displayed by a computer on a display device to perform functions on the computer, play a game, experience a simulation or “virtual reality” environment, use a computer aided design (CAD) system, browse the World Wide Web, or otherwise influence events or images depicted on the screen.

One visual environment that is particularly common is a graphical user interface (GUI). GUI's present visual images, which describe various graphical metaphors of a program or operating system that are implemented on the computer. Common GUI's include the Windows® operating system from Microsoft Corporation, the MacOS® operating system from Apple Computer, Inc., and the X-Windows GUI for Unix operating systems. The user typically moves a user-controlled graphical object, such as a cursor or pointer, across a computer screen and onto other displayed graphical objects or screen regions, and then inputs a command to execute a given selection or operation.

Other programs or environments also can provide user-controlled graphical objects such as a cursor and include browsers and other programs displaying graphical “web pages” or other environments offered on the World Wide Web of the Internet, CAD programs, video games, virtual reality simulations, etc. In some graphical computer environments, the user can provide input to control a 3-D “view” of the graphical environment, as in CAD or 3-D virtual reality applications.

The user interaction with and manipulation of the computer environment is achieved using any of a variety of types of human-computer interface devices that are connected to the computer system controlling the displayed environment. A common interface device for GUI's is a mouse or trackball. A mouse is moved by a user in a planar workspace to move a graphical object such as a cursor on the 2-dimensional display screen in a direct mapping between the position of the user manipulandum and the position of the cursor. This is typically known as “position control”, where the motion of the graphical object directly correlates to motion of the user manipulandum.

To allow the user easier control of scrolling, zooming, and other like functions when using a mouse, a “scroll wheel” or “mouse wheel” has been developed and has become quite common on computer mice. A mouse wheel is a small finger wheel provided on a convenient place on the mouse, such as between two mouse buttons, which the user can rotate to control a scrolling or zooming function. Most commonly, a portion of the wheel protrudes out of the top surface of the mouse which the user can move his or her finger over.

The wheel typically includes a rubber or other frictional surface to allow a user's finger to easily rotate the wheel. In addition, some mice provide a “clicking” wheel that moves between evenly spaced physical detent positions and provides discrete positions to which the wheel can be moved as well as providing the user with some physical feedback as to how far the wheel has rotated. The wheel is most commonly used to scroll a document in a text window without having to use a scroll bar, or to zoom a window's display in or out without selecting a separate zoom control. The wheel can also be used in other applications, such as a game, drawing program, or simulation.

Usually the wheel has a frictional feel to it. For example, some mouse wheels have physical detents, which are spaced a constant distance apart and have a tactile response when a scrolling or zooming task is performed or the characteristics of a document or view are manipulated.

Conventionally, a computer mouse is connected to a computer system by a cable for transmitting signal/power therebetween. For example, such a computer mouse is known from U.S. Pat. No. 5,912,661. The cable, however, can hinder efficient and unobstructed movement of the mouse causing inconvenience to a user. A cable-less mouse that communicates with a computer system by means of electromagnetic signals for data transmission overcomes the problem. However, since no cable connects the mouse and the computer system, the mouse has to incorporate an independent power source therein for powering itself.

U.S. Pat. No. 6,411,279 shows a cable-less mouse power saving device. The microprocessor of a computer mouse can force the mouse into an idle condition for reducing power consumption after having not received a control signal for a predetermined period of time.

The present invention aims to provide an improved interface device, computer system and method for recharging a battery of the interface device and/or computer system.

### SUMMARY OF THE INVENTION

The present invention provides for an interface device, such as a computer mouse, track ball or joystick, for interfacing a user's input with a computer. In essence, the invention enables the generation of electrical energy from mechanical energy applied by the user when a mechanical input operation is performed. The electrical energy is used to power electrical circuitry on the device for deriving an input signal for the computer. The energy preferably also recharges a battery of the interface device and/or of the computer system. This allows the time intervals for connecting the batteries to an external power source for recharging to be extended. In some applications it is even possible to completely eliminate the requirement for recharging the batteries by means of an external power source in that the electrical energy, which is generated from the mechanical input energy, is sufficient for powering the interface device and/or the computer system.

The present invention is particularly advantageous for cordless computer mice. Such cordless computer mice typically have non-rechargeable batteries which need to be replaced from time to time when the battery capacitance is exhausted. In accordance with the present invention, a rechargeable battery is used which is recharged by electrical energy, which is generated by the user input actions. This allows the time intervals for exchanging the battery to be extended or the computer mouse can even become an autonomous system as far as power supply is concerned. In this case, replacing the battery is no longer necessary in that the electrical energy generated by the mechanical user input action is sufficient to power the system. This is particularly advantageous in order to avoid downtimes of the computer system and to minimize maintenance requirements for the computer system.

In accordance with a further preferred embodiment of the present invention, the computer mouse is connected to the computer system by a cable. The cable serves to transmit both input signals and electrical energy generated by the mechanical user input actions to the computer system. The electrical energy supplied from the computer mouse to the computer system is used to recharge the batteries of the computer system. This is particularly advantageous for laptop computers or other mobile computing devices, such as Palm Top Computers and Personal Digital Assistants.

In accordance with a further preferred embodiment of the present invention, the interface device is integrated into the housing of the computer itself. This is particularly advantageous for interface devices, such as track balls or wheels, which are integrated into the housing of a laptop computer or other mobile computing device.

In accordance with a further preferred embodiment of the present invention, a wheel that is rotatably mounted on an axle is rotated by a digit of the user in order to perform an input operation. The axle is coupled to electrical energy generator for generating electrical energy when the wheel is rotated. The electrical energy generator is coupled to the battery for recharging.

In accordance with a further preferred embodiment of the present invention, the electrical energy generator is an electromagnetic device having a step motor winding configuration. This provides a pre-defined step angle for the rotation of the wheel. When the user rotates the wheel by a number of step angles, a corresponding number of electrical energy pulses is generated by the step motor winding configuration. This is particularly advantageous as the generator has a double function: it is both used to generate the electrical energy as well as to provide a segmented feel to the rotation of the wheel. In particular, this has the advantage that a separate detent mechanism is not required. Furthermore, the generator with the step motor winding configuration can also be used for determining the amount of angular movement of the wheel on the basis of the electrical energy pulses that are generated when a user rotates the wheel.

In accordance with a further preferred embodiment of the present invention, a battery type is used which can be pulse-charged. This has the advantage that the electrical energy pulses, which are generated by the step motor winding configuration, can be directly applied to the battery without filtering. Examples of such batteries, which can be pulse charged, are nickel-cadmium and nickel-metal-hydride batteries. When lithium-ion batteries are used, it is preferable to apply a smoothening filter to the electrical energy pulses before application to the lithium-ion battery in order to prevent damage to the battery.

In accordance with a further preferred embodiment of the present invention, the movement of the mouse ball is used for generating electrical energy for recharging the batteries. For example, the mouse ball can contain magnetic particles that create a static electromagnetic field surrounding the mouse ball. The movement of the mouse ball being rolled on a planar workspace induces a voltage by the moving electromagnetic field into a winding that serves as a generator. The same principle for generating electrical energy can also be implemented for a track ball.

### BRIEF DESCRIPTION OF THE DRAWINGS

Exemplary embodiments in accordance with the present invention will be described in greater detail by making reference to the drawings in which:

FIG. 1 is a perspective view of the exterior of a cordless interface device incorporating an electrical generator in accordance with the principles of the present invention;

FIG. 2 is a block diagram of the cordless interface device having a rechargeable battery;

FIG. 3 is a plan view of certain components of the interface device of FIGS. 1 and 2 with the top of the housing and the associated buttons removed;

FIG. 4 is a block diagram of a mobile computer having rechargeable batteries and being connected to an interface device by means of a cable;

FIG. 5 is a block diagram of a cordless interface device where the generator serves to detect the amount of angular movement;

FIG. 6 is a block diagram of a mobile computer having an integrated interface device; and

FIG. 7 is a flowchart of a method in accordance with an embodiment of the present invention.

### DETAILED DESCRIPTION

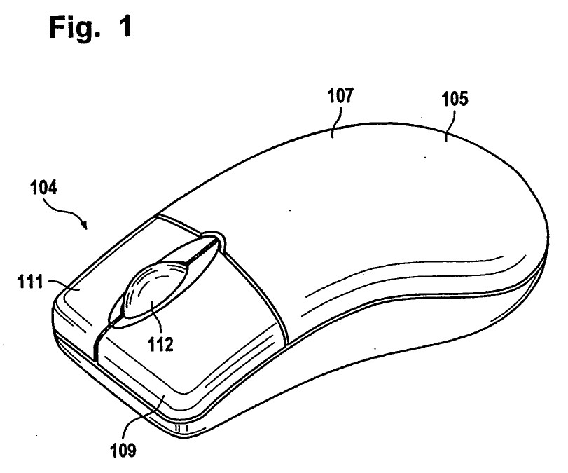

With reference to FIGS. 1 to 3, an embodiment of the present invention is illustrated in a computer mouse. As seen in FIG. 1, a mouse 104 has a plastic housing with an outer surface 105 including an upper surface 107. Left and right mouse buttons 109 and 111 are located on the upper surface 107. A rim or edge of a rotatable wheel 112 protrudes from the upper surface 107 through a space between the left and right mouse buttons 109 and 111. The surface of the mouse buttons 109 and 111 are recessed somewhat in the vicinity of the wheel 112.

While the present invention is shown for illustrative purposes within a mouse, it will be understood that the upper surface 107 shown in FIG. 1 can also be a surface of a trackball or other input device, and can be disposed other than horizontally, and can vary in other ways from the particular embodiment shown.

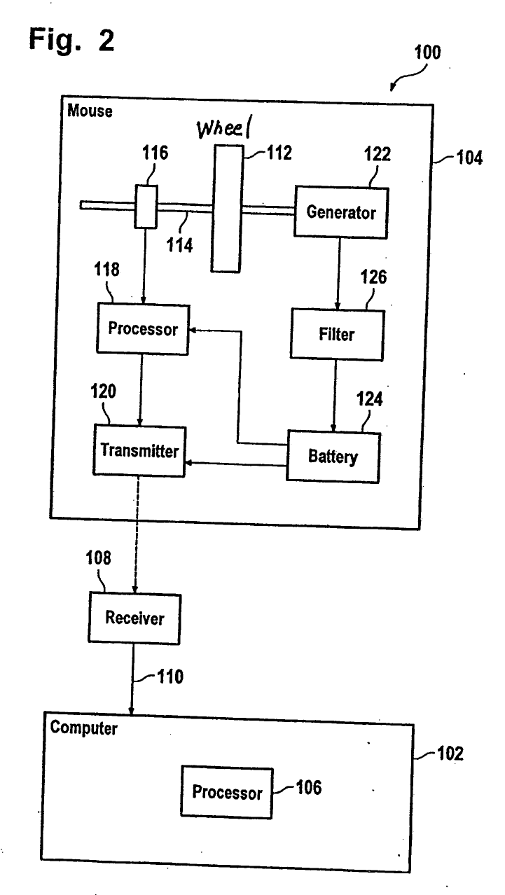

FIG. 2 is a block diagram of a computer system 100 comprising a computer 102 to which the computer mouse 104 is coupled. Computer 102 can be a personal computer having a processor 106. A receiver 108 is connected to computer 102 by a cable 110. Receiver 108 serves to receive electromagnetic or optical signals from the cordless computer mouse 104. Wheel 112 of the mouse 104 is rotatable about a wheel axle 114. Wheel 112 is arranged such that it is rotatable by a digit of a user in order to perform an input operation.

A rotation of the wheel 112 is sensed by sensor 116. Sensor 116 can be of a mechanical or optical type and detects a rotational movement of the wheel 112. The corresponding signal representative of an angular movement of the wheel 112 is provided from the sensor 116 to the processor 118 of the mouse 104. Processor 118 encodes the signal provided by the sensor 116 and provides the encoded signal to a transmitter 120. Transmitter 120 sends the encoded signal to the receiver 108 of the computer 102 for input into the processor 106.

A generator 122 is mechanically connected to the wheel axle 114. When a digit of the user rotates the wheel 112, the corresponding torque is transmitted by the wheel axle 114 to the generator 122. This torque drives the generator 122 such that the mechanical energy is transformed into electrical energy. This electrical energy is used for recharging the battery 124 of the mouse 104. Battery 124 provides power for operation of the cordless mouse 104, in particular to the processor 118 and the transmitter 120. Depending on the type of rechargeable battery 124 used, the electrical energy can either be applied directly or indirectly via a smoothening filter 126 to the battery 124.

If the battery 124 is a nickel-cadmium-cell or a nickel-metal-hydride-cell, pulses of electrical energy are preferred for recharging. In this instance, a filter 126 may not be required. However, if the battery 124 is a lithium-ion cell, the smoothening filter 126 is required in order to prevent damage to the battery 124.

It is preferred that the generator 122 has a step motor winding configuration. In fact, the generator 122 can be realized by a step motor, used as a generator rather than as a motor. Any type of step motor can be used for this purpose, such as a variable reluctance motor, permanent magnet motor or hybrid step motor.

The step motor winding configuration provides for a certain step angle. For example, the step angle can be between 0.9% and 3.6%.

It is particularly advantageous to use the generator 122 having a step motor winding configuration in combination with the battery 124 requiring pulse charging. In this instance, the energy pulses provided by the generator 122 can be directly used for recharging the battery 124 without filtering.

When a user desires to perform an input operation, the user places his or her digit on the wheel 112 and rotates the wheel 112 in order to perform a scrolling or zooming operation or the like. The user rotates the wheel 112 by an angular displacement that corresponds to the desired input operation. This angular movement is detected by the sensor 116. At the same time, the rotation of the wheel axle 114 due to the angular movement of the wheel 112 is used to drive the generator 122 which, in response thereto, generates electrical energy for recharging the battery 124. Battery 124 powers the processor 118 that encodes the signal delivered by the sensor 116 as well as the transmitter 120 which transmits the encoded signal to the receiver 108 of the computer 102.

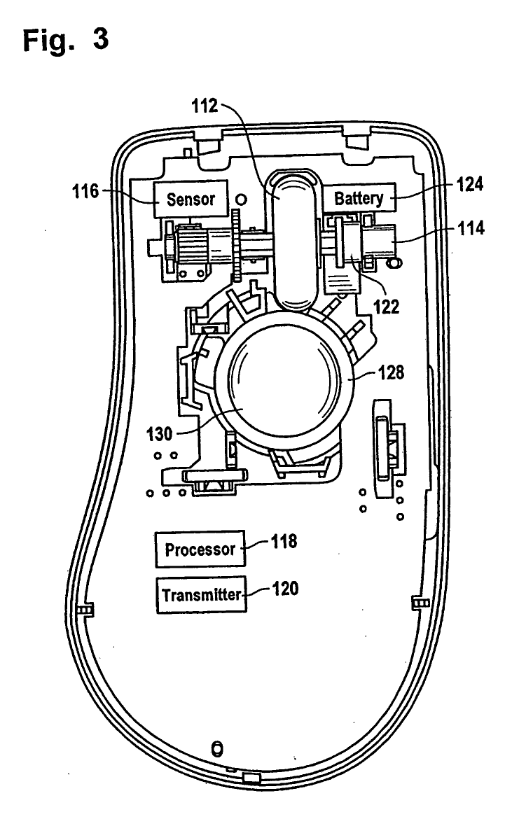

FIG. 3 is a top view of the mouse 104 with the top of the housing removed. The bottom of the housing has an opening 128 for receiving a ball 130. In addition or as an alternative, a mechanical movement of the ball 130 can be used for generating electrical energy. For this purpose, the ball 130 contains magnetic particles that form a resulting static magnetic field surrounding the ball 130. Furthermore, a cylinder coil is disposed in the opening 128 that surrounds the ball 130. When the ball 130 is rolled, the moving magnetic field induces a voltage in the coil. The coil is connected to the battery 124 such that battery 124 is recharged.

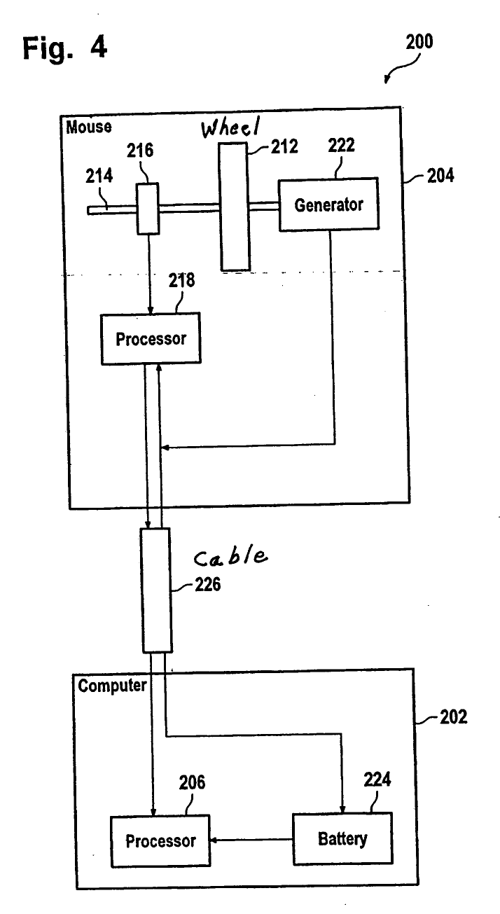

FIG. 4 is an alternative embodiment of a computer system 200. Like elements of the embodiment of FIG. 4 are designated with like reference numerals as in FIGS. 1, 2 and 3 but with 100 added thereto.

Mouse 204 is not a cable-less mouse as the mouse 104 of FIG. 1, 2 and 3, but is connected to a computer 202 by a cable 226. The cable 226 couples a processor 218 with a processor 206 such that the processor 218 can output the encoded signal provided by a sensor 216 as an input signal to the processor 206. Likewise, a generator 224 is coupled to a battery 224 of the computer 202 via the cable 226. Battery 224 powers the computer 202, in particular, the processor 206 as well as the mouse 204, and the processor 218. Battery 224 is recharged when a user performs an input action by rotating a wheel 212 in accordance with the same principles as explained with respect to FIGS. 1, 2 and 3. Rotating the wheel 212 drives the generator 222 via wheel axle 214, such that electrical energy is generated by the generator 222 and transmitted to the battery 224 for recharging.

Preferably, the computer 202 is a mobile computer, such as a laptop computer, palm top computer or personal digital assistant. The time intervals between recharging the battery 224 by an external power source can be extended by recharging the battery 224 with the energy supplied by the generator 222. If power consumption of the computer 202 is relatively low, such an external power source can even become completely unnecessary for the operation of the computer system 200.

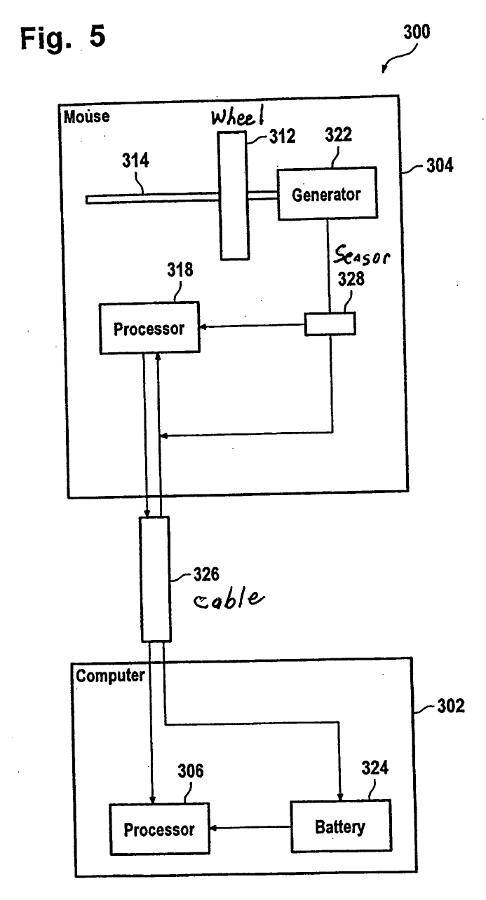

FIG. 5 is a block diagram of a variant of the embodiment of FIG. 4. Again, like elements of FIG. 5 are designated with like reference numbers with 100 added thereto.

In contrast to the computer system 200, a computer system 300 of FIG. 5 has no sensor for directly sensing an angular movement of a wheel 312. Rather, there is a sensor 328, which senses the voltage pulses generated by a generator 322. Generator 322 has a step motor winding configuration such that the number of output pulses is representative of the distance of the angular movement of the wheel 312. These output pulses are sensed by the sensor 328 and inputted into a processor 318. Processor 318 encodes the sensed voltage pulses and provides a corresponding input signal to a processor 306. The output pulses generated by the generator 322 are supplied to a battery 324 for recharging.

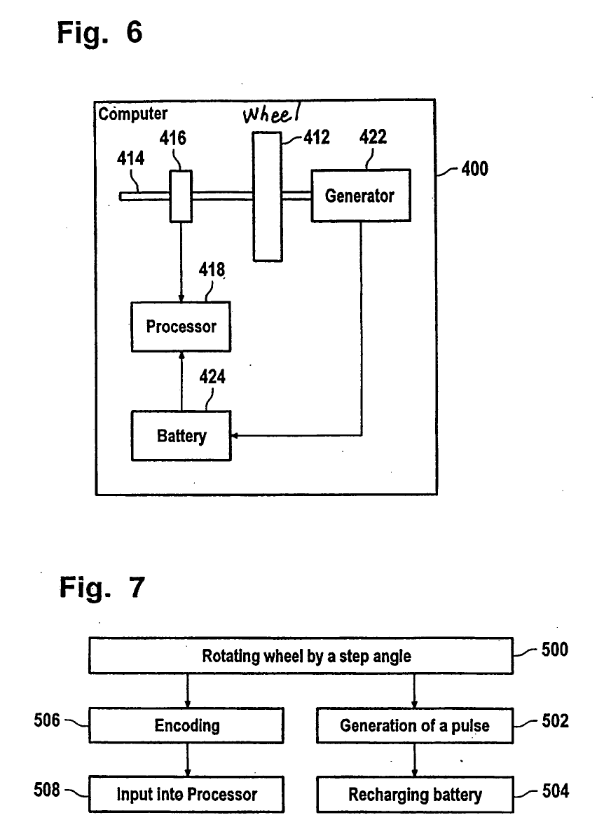

FIG. 6 is a block diagram of a mobile computer 400, such as a laptop computer. Computer 400 has a rechargeable battery 424. Computer 400 has a housing, which carries a wheel axle 414 of a wheel 412. In other words, there is no separate hardware unit forming a mechanical input device but rather, the mechanical input device is integrated into the housing of the computer. The computer housing has an opening through which a portion of the wheel 412 protrudes such that a user can rotate the wheel 412 with his or her digit. Rotation of the wheel 412 is sensed by a sensor 416 and the sensed motion is inputted into a processor 418. As in the embodiments of FIGS. 1, 2, 3, 4 and 5 the mechanical energy provided by the user by rotating the wheel 412 is converted by the generator 422 into voltage pulses that are applied to the battery 424 for the purpose of recharging.

The time interval for connecting the computer 400 to an external power source can therefore be extended. When the computer 400 has a low power consumption, such as in the case of a palm top or personal digital assistant computer, connecting the computer 400 to an external power source can even become superfluous, as the electrical energy that is generated by the mechanical input energy is sufficient to sustain operation of the system.

FIG. 7 is a flowchart of a method in accordance with an embodiment of the present invention. In step 500, the moveable mechanical element of a mechanical input device, such as a wheel, is rotated by a certain step angle. Due to the rotation, a pulse is generated in step 502 by a generator. This pulse is used in step 504 for recharging the battery of the mechanical input device or of the computer itself.

In parallel to steps 502 and 504, steps 506 and 508 are performed: in step 506 the rotation of the wheel is sensed and encoded. The encoded amount of rotational movement of the wheel is inputted into a processor in step 508 as an input signal.

1. An interface device for interfacing a user's input with a computer, the interface device comprising:
a mechanical input device adapted to transform a mechanical input operation of the user into an input signal for input into the computer, said mechanical input device having at least one movable element adapted to be moved by the user to perform the input operation;
an electrical generator mechanically coupled to said at least one moveable element to generate electrical energy in response to the input operation being performed; and
an electrical coupler adapted to electrically couple said electrical generator to a rechargeable battery for recharging said battery with said electrical energy.

2. The interface device of claim 1, wherein said at least one movable element comprises a wheel, said wheel adapted to be rotatable about a wheel axle by a digit of the user, and wherein said generator is adapted to be mechanically coupled to said wheel axle.

3. The interface device of claim 1, wherein said at least one movable element comprises a ball disposed in a housing and adapted to be rolled on a planar workspace.

4. The interface device of claim 1, wherein said at least one movable element comprises a ball disposed in a housing of the computer and adapted to be rolled by a digit of the user.

5. The interface device of claim 3, wherein said ball is magnetized and said generator comprises a winding into which a voltage is induced upon said ball being rolled.

6. The interface device of claim 1, wherein said generator comprises an electromagnetic device adapted to convert a rotation of said wheel axle for a predefined step angle into a pulse of electrical energy.

7. The interface device of claim 1, wherein said generator comprises a step motor winding configuration.

8. The interface device of claim 1, wherein said battery is adapted for pulse charging with pulses of electrical energy.

9. The interface device of claim 6, further comprising a filter adapted to smooth pulses of electrical energy before application to said battery.

10. The interface device of claim 1, further comprising a user manipulandum adapted to be moveable in two degrees of freedom in a planar workspace with respect to a ground surface, said user manipulandum carrying at least said mechanical input device and said electrical energy generator.

11. The interface device of claim 10, wherein said user maniupulandum is adapted to carry said battery and a wireless transmitter adapted to wirelessly transmit an input signal to the computer.

12. The interface device of claim 10, wherein said user manipulandum further comprises a cable adapted to transmit said input signal and electrical energy to the computer.

13. The interface device of claim 1, wherein said mechanical input device is adapted to be integrated into a housing of the computer.

14. The interface device of claim 1, further comprising electrical circuitry located in the device for deriving the input signal, the electrical circuitry having a power supply terminal including a connection to a terminal adapted to be connected to an electrode of the battery.

15. A computer system comprising:
a processor;
a mechanical input device adapted to transform a mechanical input operation of a user to an input signal for said processor, said mechanical input device having at least one movable element adapted to be moved by the user to perform an input operation;
an electrical energy generator arranged to be mechanically coupled to said at least one moveable element and arranged to generate electrical energy upon said input operation being performed; and
a rechargeable battery arranged to be electrically coupled to said generator for recharging by electrical energy.

16. The computer system of claim 15, wherein said at least one moveable element is adapted to be rotatably attached to a housing of the computer system.

17. The computer system of claim 15, further comprising electrical circuitry located in the device for deriving the input signal, the electrical circuitry having a power supply terminal including a connection to a terminal adapted to be connected to an electrode of the battery.

18. A method of recharging a battery, the method comprising:
performing a mechanical input operation by applying mechanical energy to a moveable element to move the moveable element a distance;
generating an input signal for a computer in response to the movement of the moveable element;
transforming the movement of the moveable element into electrical energy; and
recharging a battery that powers circuitry for deriving the input signal with the electrical energy.

19. The method of claim 18, wherein the mechanical input operation comprises rotating a wheel about a wheel axle to which an electrical energy generator is coupled.

20. The method of claim 19, wherein the rotation of the wheel comprises rotating in pre-defined step angles and generating a pulse of electrical energy for each step angle of rotation.

21. The method of claim 20, further comprising smoothing the pulses of electrical energy before application to the battery.

22. The method of claim 18, wherein the mechanical input operation comprises rolling a ball on a planar workspace.

23. A cordless computer mouse comprising:
a battery;
a manually operable actuator arranged within the mouse; and
a transducer adapted to be electrically connected to said battery and mechanically connected to said manually operable actuator;
wherein said transducer is adapted to transduce kinetic energy of said manually operable actuator into electrical energy for charging the battery.

24. The cordless computer mouse according to claim 23, wherein said manually operable actuator comprises a ball arranged within the mouse and adapted to rotate upon the mouse being mechanically translated.

25. The cordless computer mouse according to claim 23, wherein said manually operable actuator comprises a wheel arranged within the mouse and adapted to rotate to navigate a user interface on a computer electrically connected to the mouse.

26. An interface device for interfacing a user's input with a computer, the interface device comprising:
a mechanical input device adapted to transform a mechanical input operation of the user into an input signal for input into the computer, said mechanical input device having at least one movable element adapted to be moved by the user to perform the input operation;
an electrical generator mechanically coupled to said at least one moveable element to generate electrical energy in response to the input operation being performed; and
an electrical coupler for causing the generate electrical energy to power electrical circuitry for deriving the input signal.

27. The interface device of claim 26, wherein the electrical circuitry includes a wireless transmitter for coupling an indication of the signal to the computer.
